(19) United States
(12) Patent Application Publication
(10) Pub. No.: US 2020/0273213 A1
(43) Pub. Date: Aug. 27, 2020

(54) CONFIGURATION FOR MODIFYING A COLOR FEATURE OF AN IMAGE

(71) Applicant: THOMSON LICENSING, Issy-les-Moulineaux (FR)

(72) Inventor: Joshua PINES, San Francisco, CA (US)

(21) Appl. No.: 16/066,139

(22) PCT Filed: Dec. 31, 2015
(86) PCT No.: PCT/US2015/068289

§ 371 Date: Jun. 26, 2018

(51) Int. Cl. G06T 11/00; G06T 11/60; G06T 7/90

(52) U.S. Cl. CPC G06T 11/001; G06T 2207/10024; G06T 7/90; G06T 11/60

(57) ABSTRACT

An image editing apparatus includes a processor. Further, the image editing apparatus includes a memory having a set of instructions that when executed by the processor causes the image editing apparatus to generate a source image representation of a source image in a first color space. In addition, the image editing apparatus is caused to generate one or more source characteristic measurements based upon the source image representation. The image editing apparatus is also caused to generate a destination image representation of a destination image in a second color space. The destination image has a distinct structure from the source image. Further, the image editing apparatus is caused to transform one or more destination characteristic measurements of the destination image representation based upon the one or more destination characteristic measurements of the source image representation.

### BACKGROUND

### 1. Field

This disclosure generally relates to the field of media editing systems. More particularly, the disclosure relates to color correction systems for media editing.

### 2. General Background

Various media editing systems allow a colorist to edit a particular image or video prior to production. Such media editing systems typically allow the colorist to manually adjust properties, e.g., color features, of the image or video through a color correction process. The color correction process may be utilized for establishing a particular look for the image or video, reproduction accuracy, compensating for variations in materials utilized during image capture, or to enhance certain features of a scene.

A media editing system analyzes a color palette of an image or video to be edited by determining the pixel values of that image or video based upon a particular color model, i.e., an abstract mathematical model that provides a numerical representation for colors of the color palette. An example of the numerical representation is a tuple, e.g., a finite ordered list of elements. The color space for the color model describes the type and quantity of colors that result from combining the different colors of the color model. For example, the RGB model is a model based on the color components of red, green and blue that is each represented as a coordinate in a 3D coordinate system. Each color is a combination represented as a tuple of three coordinates, e.g., x, y, and z, in the 3D coordinate system. The color space for a particular RGB model describes the number of colors, e.g., tuple representations, that result from the possible points in the 3D coordinate system.

Various other types of color models that do not rely on a 3D coordinate system are also utilized by colorists. For example, HSL is a model based on hue, saturation, and luminance that utilizes a cylindrical coordinate representation for points in an RGB color model. Further, HSV is a model based on hue, saturation, and value that is also based on a cylindrical coordinate representation for points in an RGB color model.

Yet another example of a color space is the L*a*b* color space, which is device independent such that colors are defined independently of the computing system on which they are generated. The L*a*b* color space is typically defined via a 3D integer coordinate system. The L* is the luminance coordinate that varies from dark black at L*=0 to bright white at L*=100. Further, a* is the color coordinate that represents red and green. The red values are represented by a positive a* coordinate whereas the green values are represented by a negative a* coordinate. In addition, b* is the color coordinate that represents blue and yellow. The yellow values are represented by a positive b* coordinate whereas the blue values are represented by a negative b* coordinate. Neutral grey may be represented by a* equaling zero and b* equaling zero.

After determining a particular color space for an image, the colorist may edit the various pixel values of the pixels in that image according to the color space. The colorist can thereby change color features of an image or video.

### SUMMARY

An image editing apparatus includes a processor. Further, the image editing apparatus includes a memory having a set of instructions that when executed by the processor causes the image editing apparatus to generate a source image representation of a source image in a first color space. In addition, the image editing apparatus is caused to generate one or more source characteristic measurements based upon the source image representation. The image editing apparatus is also caused to generate a destination image representation of a destination image in a second color space. The destination image has a distinct structure from the source image. Further, the image editing apparatus is caused to transform one or more destination characteristic measurements of the destination image representation based upon the one or more source characteristic measurements of the source image representation.

In addition, a process generates, with a processor, a source image representation of a source image in a first color space. The process also generates, with the processor, one or more source characteristic measurements based upon the source image representation. In addition, the process generates, with the processor, a destination image representation of a destination image in a second color space. The destination image has a distinct structure from the source image. The process also transforms, with the processor, one or more destination characteristic measurements of the destination image representation based upon the one or more source characteristic measurements of the source image representation.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a feature modification system.

FIG. 2 illustrates the internal components of the feature modification device illustrated in FIG. 1.

FIG. 3 illustrates a process that may be utilized by the processor illustrated in FIG. 2 to perform feature modification of the destination image based upon a feature of the source image.

FIG. 4 illustrates an example of a color space for the source image illustrated in FIG. 1.

FIG. 5 illustrates an example of a color space for the destination image illustrated in FIG. 1.

FIG. 6 illustrates a bounding box representation that the processor illustrated in FIG. 2 may generate based upon the point cloud of the color space illustrated in FIG. 4.

FIG. 7 illustrates a bounding box representation that the processor illustrated in FIG. 2 may generate based upon the point cloud of the color space illustrated in FIG. 5.

FIG. 8 illustrates an example of the bounding box representation illustrated in FIG. 6 being applied to the bounding box representation illustrated in FIG. 7.

FIG. 9 illustrates an example of a transformed bounding box representation that is modified based upon the luminance feature that is isolated from the bounding box representation illustrated in FIG. 8.

FIG. 10 illustrates an ellipsoidal representation that the processor illustrated in FIG. 2 may generate based upon the point cloud of the color space illustrated in FIG. 4 by utilizing principal component analysis (“PCA”).

FIG. 11 illustrates a vector analysis of a feature that is extracted from the ellipsoid representation illustrated in FIG. 10.

FIG. 12 illustrates an ellipsoidal representation that the processor illustrated in FIG. 2 may generate based upon the point cloud of the color space illustrated in FIG. 5 by utilizing PCA.

FIG. 13 illustrates a vector analysis of a feature that is extracted from the ellipsoid representation illustrated in FIG. 11.

FIG. 14 illustrates an example of a transformed ellipsoidal representation that is modified based upon the luminance feature that is isolated from the ellipsoidal representation illustrated in FIG. 10.

### DETAILED DESCRIPTION

A configuration is provided to modify one or more features of a destination image, i.e., the image to be modified, to match one or more corresponding features of a source image, i.e., the image from which the features originate. In other words, the destination image may be modified to have the look of the source image. As an example, the particular colors utilized by a destination image of a movie may be modified to have the same type of colors as a source image from a different movie. For instance, the configuration may modify a particular shade of green utilized in the scenery of a movie to match the shade of green utilized in a different movie.

The configuration analyzes the source image in a particular color space to obtain a representation of the source image in that color space. The configuration then transforms coordinates of pixel values, i.e., points in a color space, of the destination image to perform a color correction to match the color features of the destination image to the color features of the source image. The configuration may be implemented in a variety of media editing systems. Further, the configuration may also be implemented in a variety of devices, e.g., cameras, smartphones, tablets, smartwatches, set top boxes, etc. For example, camera filters and effects, e.g., smartphone wallpapers, that are stored on such a device may be modified to have the look of an image stored, viewed, captured, downloaded, etc. by that device. As a result, an arbitrary image may be modified to have the look of a different image that is structured differently than that arbitrary image. For instance, a scene from an action movie may be modified to have the look, e.g., color properties, of a scene from a comedy.

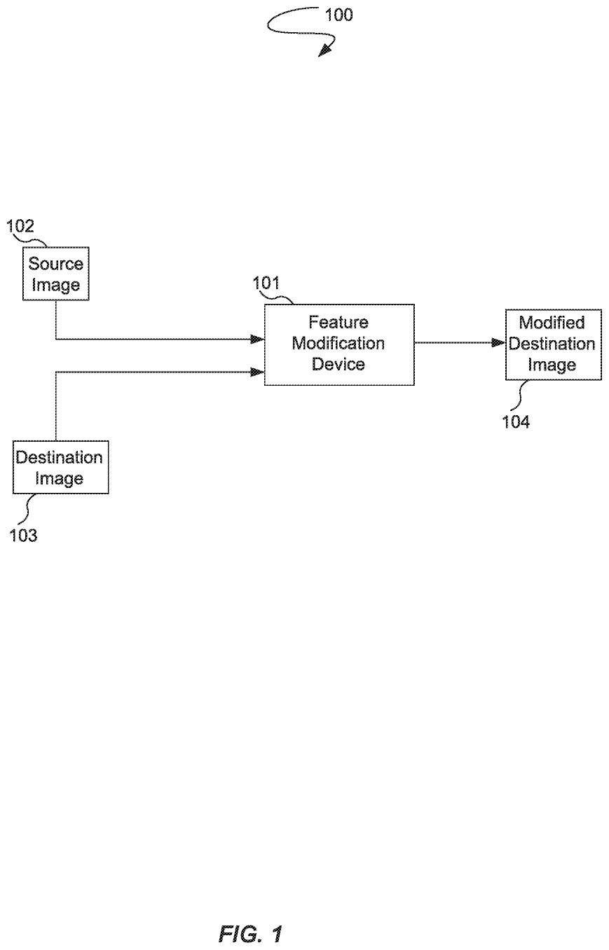

FIG. 1 illustrates a feature modification system 100. The feature modification system 100 includes a feature modification device 101. Various embodiments of the feature modification device 101 include computing devices such as a personal computer (“PC”), laptop computer, server computer, smartphone, tablet, smartwatch, set top box, etc. The feature modification device 101 receives a source image 102 and a destination image 103. The feature modification device 101 generates a representation of the source image 102 and a representation of the destination image 103 according to the frequency of color features found in each of the source image 102 and destination image 103. For example, the feature modification device 101 may generate a point cloud, which may also be referred to as a color histogram, of the frequency of different types of color features for a particular color space for each of the source image 102 and the destination image 103. The feature modification device 101 may then generate representations of the histogram plots that may be utilized for analyses and transformations. For instance, geometric representations of the histogram plots such as a box representation generated via a Bounding Box process, an ellipsoid representation generated via a PCA process, etc., may be utilized to analyze the source image 102 and the destination image 103 to determine a best fit approximation of a geometrical representation that covers all of the image pixels for a point cloud plot of an image in a particular color space.

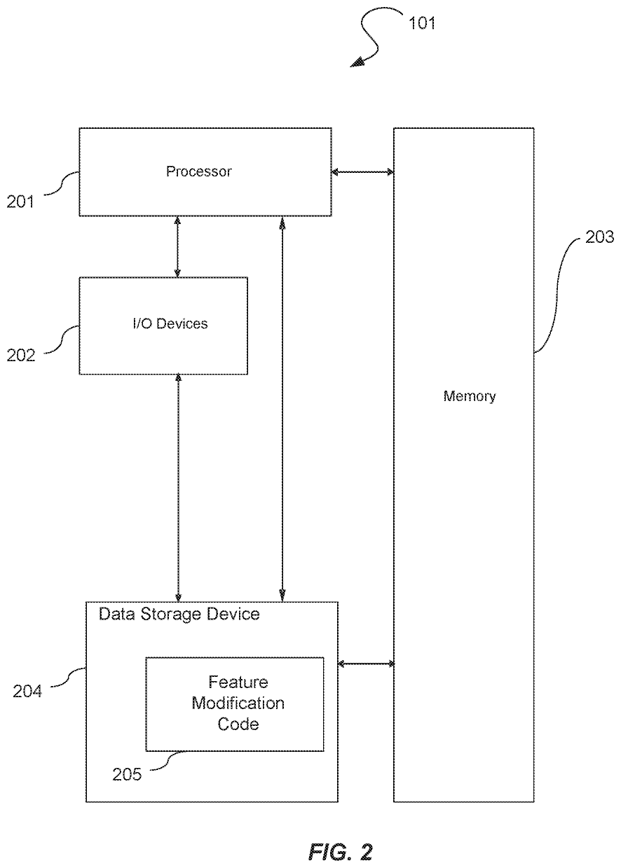

FIG. 2 illustrates the internal components of the feature modification device 101 illustrated in FIG. 1. The feature modification device 101 includes a processor 201, various input/output devices 202, e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device such as a keyboard, a keypad, a mouse, and the like, or a microphone for capturing speech commands, a memory 203, e.g., random access memory (“RAM”) and/or read only memory (“ROM”), a data storage device 204, and feature modification code 205.

The processor 201 may be a specialized processor that is specifically configured to execute the feature modification code 205 on the feature modification device 101 to perform a feature modification process to modify a feature of the destination image 103 to match that of the source image 102 illustrated in FIG. 1. Rather than relying on a cumbersome and laborious process of receiving user inputs of subjective comparisons between the source image 102 and the destination image 103 to extract features and perform modifications based on such features, the processor 201 improves the processing speed of a media editing system by generating a representation of features based upon frequency of those features in the corresponding image and performing a transformation based upon the representation of that feature. The technology-based problem of color correction for transformation of a destination image 103 to have one or more of the same features, e.g., color properties, as the source image 102, which has a distinct structure from the destination image, was performed manually through previous computing systems that relied on user input subjective comparisons between the images. As a result, previous configurations were often inaccurate and had computational inefficiencies that led to processing delays. In contrast, the processor 201 improves the functioning of a computer by improving the computational efficiency for which a computer is able to edit the destination image 103 based upon the source image 102 that has a distinct structure from the destination image 103. The processor 201 generates one or more characterization measurements based upon the representation of the source image 102. Further, the processor 201 may utilize the one or more characteristic measurements to transform the destination image 103 according to a feature of the source image 102.

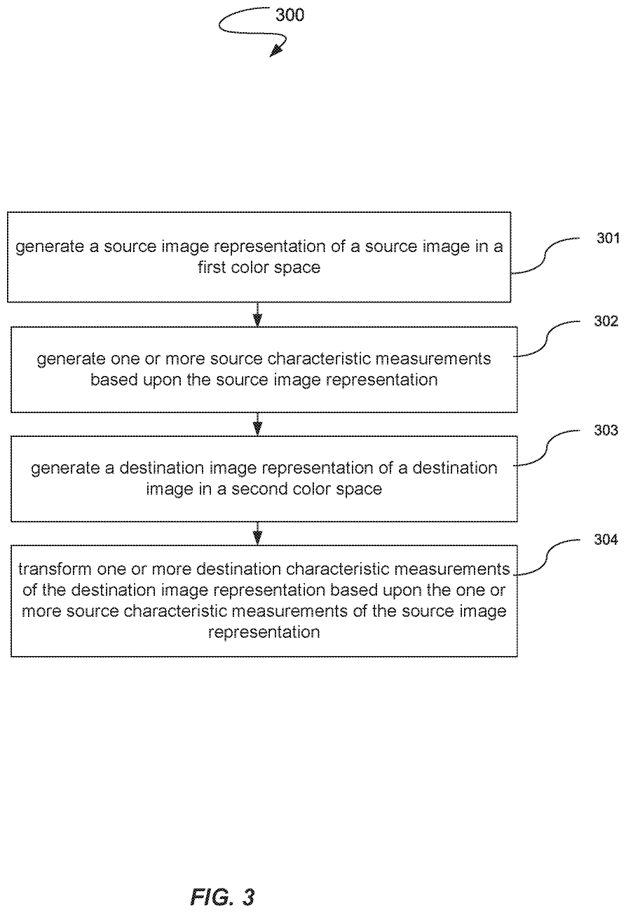

FIG. 3 illustrates a process 300 that may be utilized by the processor 201 illustrated in FIG. 2 to perform feature modification of the destination image 103 based upon a feature of the source image 102. At a process block 301, the process 300 generates a source image representation of the source image 102 in a first color space. For example, the process 300 may generate a geometric representation, e.g., a box based upon the Bounding Box approach, an ellipsoid based upon PCA, etc., that provides a best fit for all of the points, e.g., pixel values, in a point cloud of the source image 102 in a 3D coordinate space, e.g., RGB, L*a*b*, etc. Further, at a process block 302, the process 300 generates one or more source characteristic measurements based upon the source image representation. In other words, the process 300 may extract a feature from the source image representation and quantify that feature, e.g., through one or more numerical characterizations. For example, a source characteristic measurement may be a luminance value that is plotted on the L* axis of the L*a*b* color space for the source image representation.

In addition, at a process block 303, the process 300 generates a destination image representation of the destination image 103 in a second color space. The destination image 103 has a distinct structure from the source image 102. In other words, the destination image 103 is a distinct image from the source image 102. For example, the source image 102 may be a picture of a person whereas the destination image 103 may be a picture of an object. The source image 102 and the destination image 103 may have certain similarities, e.g., a picture of a person and a picture of an object captured in the same place, two different perspective image captures of the same object in the same place, etc., but the source image 102 and the destination image 103 are different in structure such that at least one image portion of the source image 102 is a different image portion than the corresponding portion of the destination image 103.

In various embodiments, the second color space is the same color space as the first color space. As a result, the coordinate system for the source image representation may be the same coordinate system for the destination image representation. In various embodiments, the second color space is a distinct color space from the first color space. Therefore, the coordinate system for the destination image representation may be different from the coordinate system for the source image representation.

At a process bock 304, the process 300 transforms one or more destination characteristic measurements of the destination image representation based upon the one or more source characteristic measurements of the source image representation. For example, the process 300 may transform the L* axis of the destination image representation based upon the L* axis value of the source image representation.

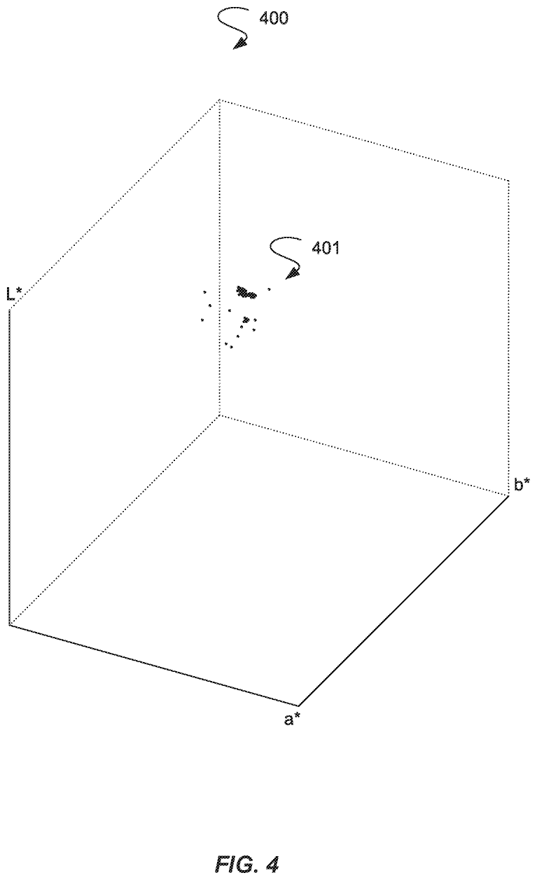

FIG. 4 illustrates an example of a color space 400 for the source image 102 illustrated in FIG. 1. Although L*a*b* is illustrated as the color space 400 for illustrative purposes, various other color spaces, e.g., RGB, HSL, HSV, YUV, YIQ, CMYK, YPbPr, xvYCC, etc., may also be utilized. Further, an example of a point cloud 401 is illustrated in the color space 400. The point cloud 401 includes all of the points, e.g., pixel values, that are each plotted according to a corresponding L* value, a* value, and b* value in the 3D L*a*b* coordinate color space. The point cloud 401 is denser at areas of higher frequency than the areas of lower frequency.

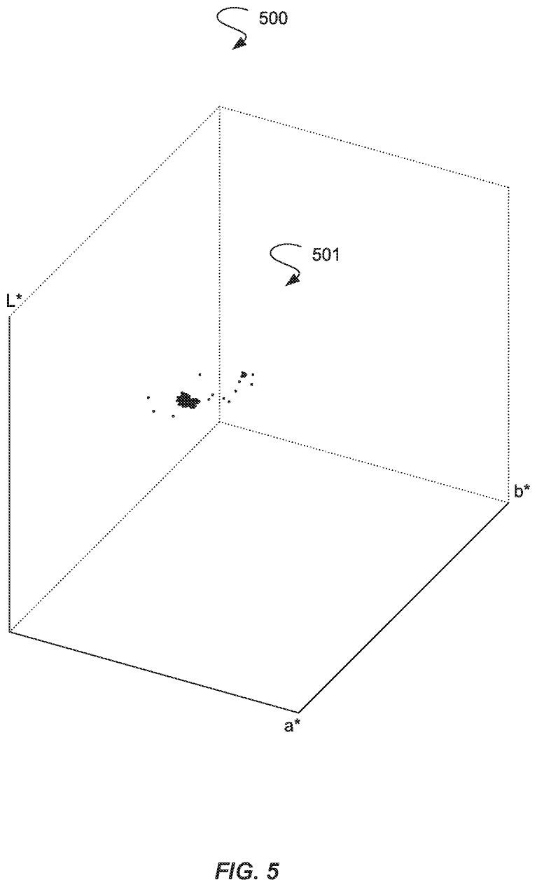

FIG. 5 illustrates an example of a color space 500 for the destination image 103 illustrated in FIG. 1. Although the color space 500 is illustrated as being the same color space as the color space 400 illustrated in FIG. 4, various embodiments include the color space 500 being a different color space from the color space 400. Further, a point cloud 501 is illustrated in FIG. 5 as being distinct from the point cloud 401 in FIG. 4. For instance, the luminance values on the L* axis of the point cloud 401 are mostly higher than the luminance values on the L* axis of the point cloud 501. In other words, the source image 102 emits or reflects more light than the destination image 103.

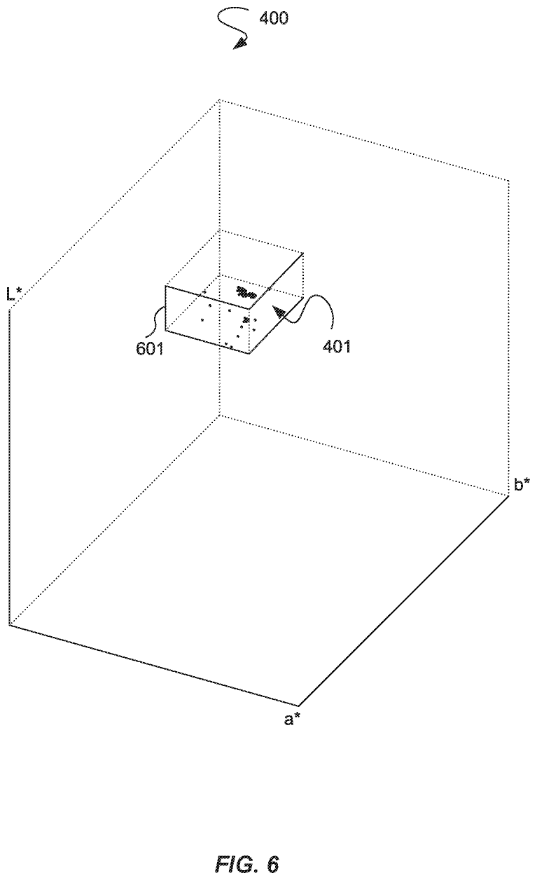

FIG. 6 illustrates a bounding box representation 601 that the processor 201 illustrated in FIG. 2 may generate based upon the point cloud 401 of the color space 400 illustrated in FIG. 4. The processor 201 determines a box according to a best fit approach, i.e., a box that minimally covers the point cloud 401. The bounding box representation 601 may then be utilized to transform a feature of the destination image 103 illustrated in FIG. 1.

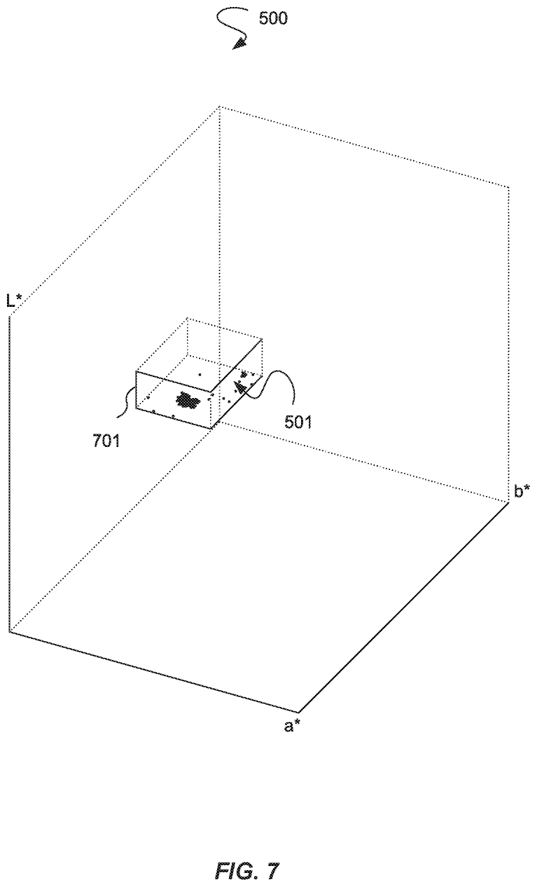

FIG. 7 illustrates a bounding box representation 701 that the processor 201 illustrated in FIG. 2 may generate based upon the point cloud 501 of the color space 500 illustrated in FIG. 5. The bounding box representation 701 may then be transformed by the processor 201 to match a feature of the bounding box representation 601 illustrated by FIG. 6.

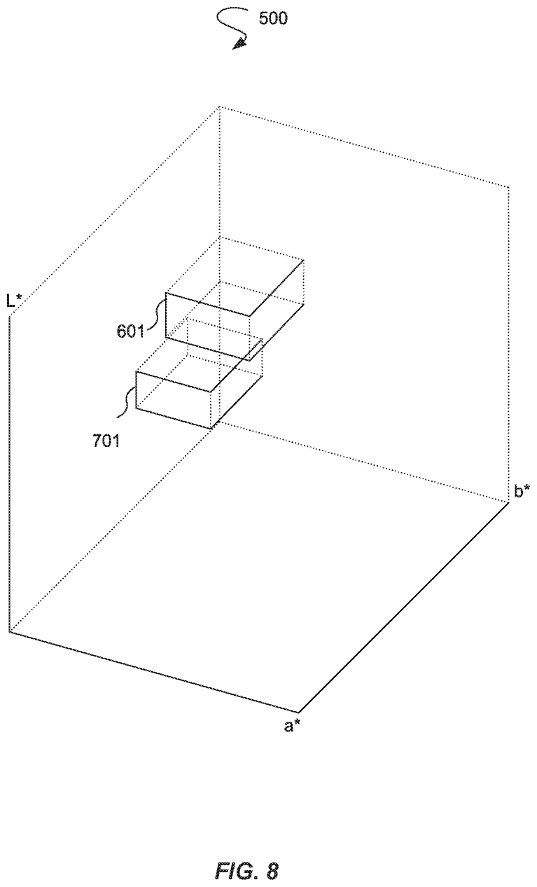

FIG. 8 illustrates an example of the bounding box representation 601 illustrated in FIG. 6 being applied to the bounding box representation 701 illustrated in FIG. 7. The bounding box representation 601 is positioned in the color space 500 according to the same position at which the bounding box representation 601 was located in the color space 400. The processor 201 may then determine, either automatically or via a user input, which feature, e.g., axis, of the bounding box representation 601 is utilized to modify the bounding box representation 701 for feature modification of the destination image 103 illustrated in FIG. 1. In various embodiments, all of the axes of the bounding box representation 701 may be transformed to match all of the axes of the bounding box representation 601. As a result, the destination image 103 would be transformed to have the color palette, i.e., all of the color properties, of the source image 102.

In various other embodiments, a subset of the axes of the bounding box representation 701 may be transformed to match a subset of the axes of the bounding box representation 601. As an example, the feature to be modified may be luminance. Accordingly, the L* axis of the bounding box representation 701 is matched to the L* axis of the bounding box representation 601. The remaining axes, e.g., the color axes, of the bounding box representation 701 remain unmodified. In other words, the luminance axis of the bounding box representation 701 is transformed such that the destination image.

Further, in various embodiments, a feature from one color space may be utilized to modify a feature of a distinct color space. For example, the luminance axis of an L*a*b* color space may be extracted to be utilized in place of a saturation axis in an HSV color space.

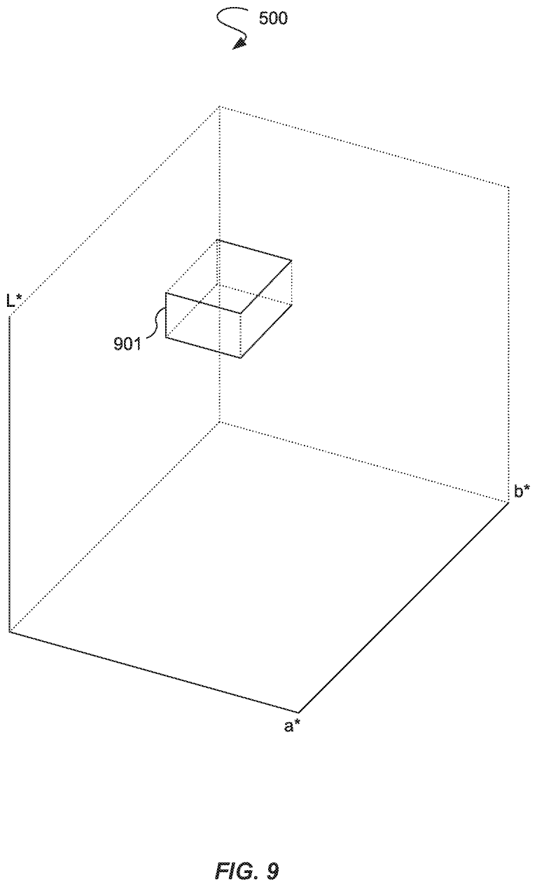

FIG. 9 illustrates an example of a transformed bounding box representation 901 that is modified based upon the luminance feature that is isolated from the bounding box representation 601 illustrated in FIG. 8. The transformed bounding box representation 901 is a composite bounding box representation that includes the extracted feature from the bounding box representation 601, e.g., luminance, and the remaining unmodified features from the bounding box representation 701, e.g., colors. As a result, the destination image 103 is modified to have a feature of the source image 102.

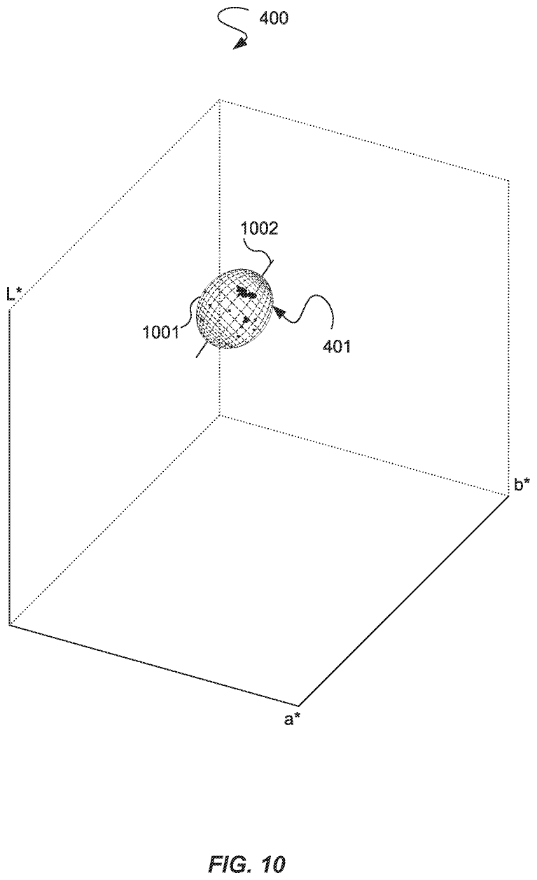

In various embodiments, the PCA approach may be utilized to determine a best fit for the point cloud 401 illustrated in FIG. 4 and the point cloud 501 illustrated in FIG. 5 instead of the bounding box approach. FIG. 10 illustrates an ellipsoidal representation 1001 that the processor 201 illustrated in FIG. 2 may generate based upon the point cloud 401 of the color space 400 illustrated in FIG. 4 by utilizing PCA. The processor 201 determines an ellipsoid according to the best fit approach, i.e., an ellipsoid that minimally covers the point cloud 401. The ellipsoidal representation 1001 may then be utilized to transform a feature of the destination image 103 illustrated in FIG. 1.

PCA is utilized to convert a set of correlated variables into a set of principal components that are uncorrelated via an orthogonal transformation. The resulting principal components are eigenvectors that represent the orthogonal directions of the ellipsoid representation 1001, i.e., the directions of axes for the ellipsoidal representation 1001. The eigenvalue is the scalar variance on the particular axis. For instance, the square root of an eigenvalue may be utilized as the length of the eigenvalue. PCA selects the first principal component based upon the most significant variance in the data. Since the most amount of variance in an ellipsoid occurs on the major axis of the ellipsoid, the first principal component is the major axis 1002 of the ellipsoid representation 1001. PCA can also be utilized to calculate the minor axes of the ellipsoid based on lesser amounts of variance than the major axis 1002.

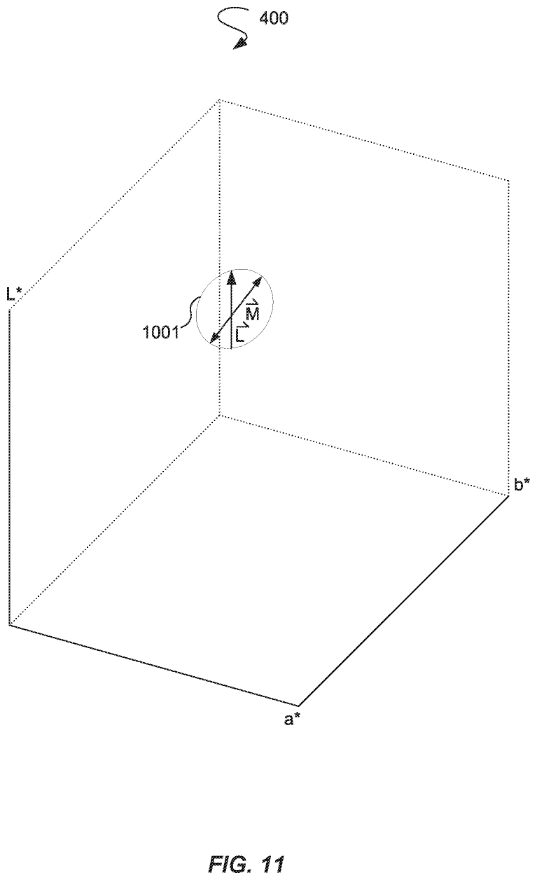

To extract a particular feature of the ellipsoid representation 1001, e.g., an axis of the color space 400 such as L*, the processor 201 analyzes a principal component, e.g., the major axis of the ellipsoid representation 1001. FIG. 11 illustrates a vector analysis of a feature that is extracted from the ellipsoid representation 1001 illustrated in FIG. 10. The major axis 1002 illustrated in FIG. 10 has a vector component M and a vector component L. The processor 201 illustrated in FIG. 2 determines one or more characteristic measurements by calculating M and L. Further, the processor 201 determines a dot product of the vector M and the vector L. The dot product is the scalar luminance component that is utilized for modification of the luminance of the destination image 103 illustrated in FIG. 1.

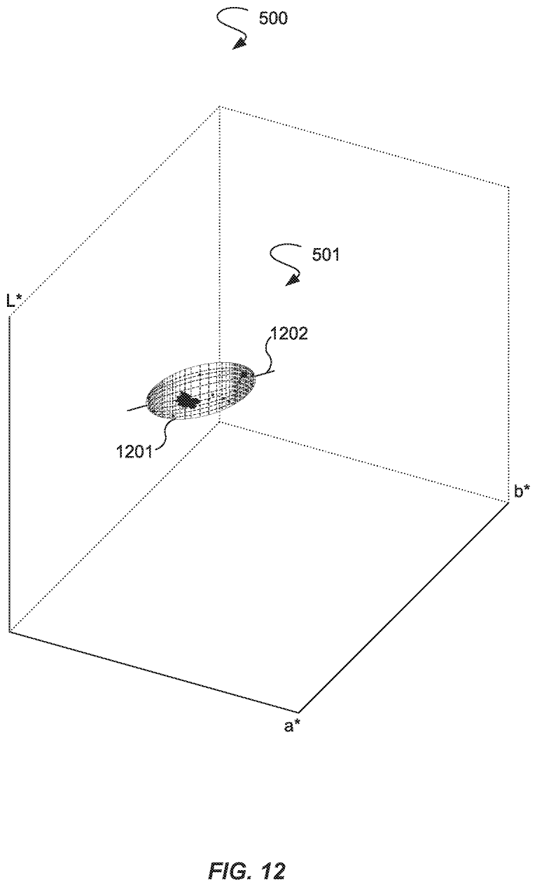

FIG. 12 illustrates an ellipsoidal representation 1201 that the processor 201 illustrated in FIG. 2 may generate based upon the point cloud 501 of the color space 500 illustrated in FIG. 5 by utilizing PCA. The processor 201 determines an ellipsoid according to the best fit approach, i.e., an ellipsoid that minimally covers the point cloud 501. The ellipsoidal representation 1201 may then be modified so that a feature of the source image 102 is matched to the destination image 103 illustrated in FIG. 1. As an example, the luminance feature of the ellipsoidal representation 1001 illustrated in FIG. 10 may be utilized to modify the luminance of the ellipsoidal representation 1201. The processor 201 illustrated in FIG. 2 may utilize a characteristic measurement, e.g., the dot product of M and L, to scale the luminance of the ellipsoidal representation 1201.

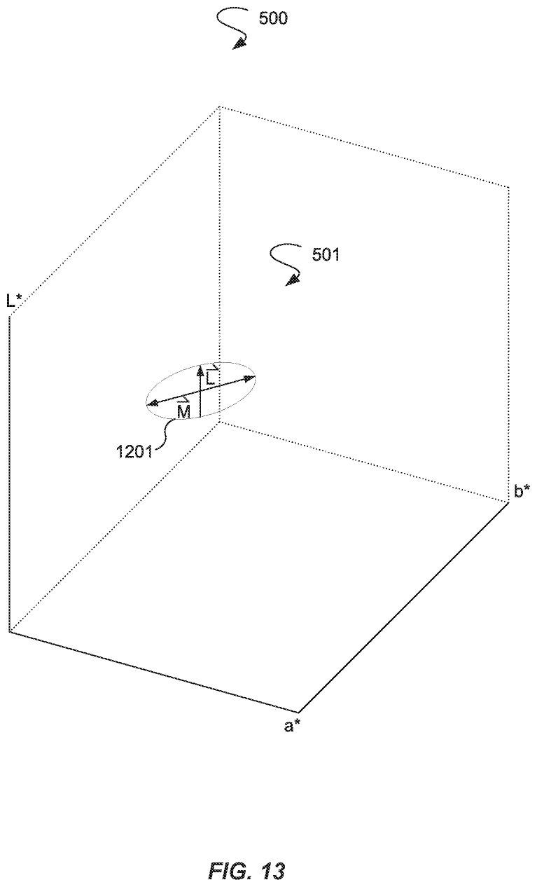

FIG. 13 illustrates a vector analysis of a feature that is extracted from the ellipsoid representation 1201 illustrated in FIG. 11. The major axis 1202 illustrated in FIG. 12 has a vector component M and a vector component L. The processor 201 illustrated in FIG. 2 scales the dot product of the vector component M and the vector component L illustrated in FIG. 13 to be equal to the dot product of the major axis 1002 illustrated in FIG. 10.

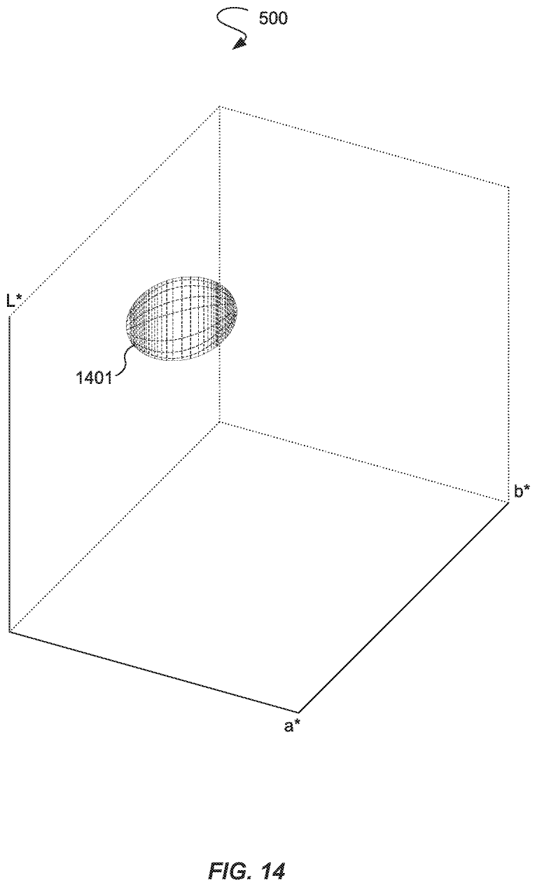

FIG. 14 illustrates an example of a transformed ellipsoidal representation 1401 that is modified based upon the luminance feature that is isolated from the ellipsoidal representation 1001 illustrated in FIG. 10. The transformed ellipsoidal representation 1401 is a composite ellipsoidal representation that includes the extracted feature from the ellipsoidal representation 1001, e.g., luminance, and the remaining unmodified features from the ellipsoidal representation 1201, e.g., colors. As a result, the destination image 103 is modified to have a feature of the source image 102.

The configurations described herein allow a user, e.g., a director, colorist, media editor, etc., isolate a color feature of a source image and then automatically apply, e.g., with the processor 201 illustrated in FIG. 2, a modification to a destination image to have that feature. The user is thereby given the ability to select particular features, e.g. only hues and colors without luminance, for feature modification. In other words, the user does not have to match every feature from the source image 102 to the destination image 103, but rather can select the optimal features for a particular image, scene, video, etc.

Further, the configurations described herein allow a user of a consumer electronics device, e.g., smartphone, tablet device, smartwatch, set top box, etc., to automatically change the appearance of a corresponding display based upon an image that is viewed, downloaded, captured, etc. For example, a user that is perusing the Internet may find a wallpaper image and take a screenshot of that wallpaper image. The user may then automatically edit the wallpaper of a consumer electronic device display based upon an isolated feature from the screenshot that the user captured.

The processes described herein may be implemented by the processor 201 illustrated in FIG. 2. Such a processor will execute instructions, either at the assembly, compiled or machine-level, to perform the processes. Those instructions can be written by one of ordinary skill in the art following the description of the figures corresponding to the processes and stored or transmitted on a computer readable medium such as a computer readable storage device. The instructions may also be created using source code or any other known computer-aided design tool. A computer readable medium may be any medium capable of carrying those instructions and include a CD-ROM, DVD, magnetic or other optical disc, tape, silicon memory, e.g., removable, non-removable, volatile or non-volatile, packetized or non-packetized data through wireline or wireless transmissions locally or remotely through a network. A computer is herein intended to include any device that has a general, multi-purpose or single purpose processor as described above.

The use of “and/or” and “at least one of” (for example, in the cases of “A and/or B” and “at least one of A and B”) is intended to encompass the selection of the first listed option (A) only, or the selection of the second listed option (B) only, or the selection of both options (A and B). As a further example, in the cases of “A, B, and/or C” and “at least one of A, B, and C,” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as listed.

It is understood that the processes, systems, apparatuses, and compute program products described herein may also be applied in other types of processes, systems, apparatuses, and computer program products. Those skilled in the art will appreciate that the various adaptations and modifications of the embodiments of the processes, systems, apparatuses, and compute program products described herein may be configured without departing from the scope and spirit of the present processes and systems. Therefore, it is to be understood that, within the scope of the appended claims, the present processes, systems, apparatuses, and compute program products may be practiced other than as specifically described herein.

1. An image editing apparatus comprising:
a processor; and
a memory having a set of instructions that when executed by the processor causes the image editing apparatus to:
generate a source image representation of a source image in a first color space comprising a best fit representation of all points in a point cloud of the source image;
generate a source characteristic measurement based upon the source image representation;
generate a destination image representation of a destination image in a second color space, the destination image being different from the source image; and
transform a destination characteristic measurement of the destination image representation based upon the source characteristic measurement of the source image representation.

2. The image editing apparatus of claim 1, wherein the first color space is equal to the second color space.

3. The image editing apparatus of claim 1, wherein the first color space is distinct from the second color space.

4. The image editing apparatus of claim 1, wherein the source characteristic measurement corresponds to a feature that is a subset of features corresponding to the source image representation.

5. The image editing apparatus of claim 4, wherein the feature is an axis from the source image representation corresponding to a color property in the first color space.

6. The image editing apparatus of claim 5, wherein the image editing apparatus is further caused to generate a composite destination image representation that includes the axis from the source image representation and at least one axis from the destination image representation.

7. The image editing apparatus of claim 1, wherein the source image representation is an ellipsoid and the destination image representation is an ellipsoid.

8. The image editing apparatus of claim 1, wherein the image editing apparatus is further caused to generate the source image representation and the destination image representation with principal component analysis.

9. The image editing apparatus of claim 1, wherein at least one of the first color space and the second color space is selected from the group consisting of: L*a*b*, RGB, YUV, HSV, HSL, and XYZ.

10. (canceled)

11. A method comprising:
generating, with a processor, a source image representation of a source image (102) in a first color space (400) comprising a best fit representation of all points in a point cloud of the source image;
generating, with the processor, a source characteristic measurement based upon the source image representation;
generating, with the processor, a destination image representation of a destination image in a second color space, the destination image having a distinct structure from the source image; and
transforming, with the processor, a destination characteristic measurement of the destination image representation based upon the source characteristic measurement of the source image representation.

12. The method claim 11, wherein the first color space is equal to the second color space.

13. The method of claim 11, wherein the first color space is distinct from the second color space.

14. The method of claim 11, wherein the source characteristic measurement corresponds to a feature that is a subset of features corresponding to the source image representation.

15. The method of claim 14, wherein the feature is an axis from the source image representation corresponding to a color property in the first color space.

16. The method of claim 15, further comprising generating a composite destination image representation that includes the axis from the source image representation and at least one axis from the destination image representation.

17. The method of claim 11, wherein the source image representation is an ellipsoid and the destination image representation is an ellipsoid.

18. The method of claim 11, further comprising generating the source image representation and the destination image representation with principal component analysis.

19. The method of claim 11, wherein at least one of the first color space and the second color space is selected from the group consisting of: L*a*b*, RGB, YUV, HSV, HSL, and XYZ.

20. (canceled)

21. A non-transitory computer-readable medium storing computer-readable program instructions for performing a method comprising:
generating, with a processor, a source image representation of a source image in a first color space comprising a best fit representation of all points in a point cloud of the source image;
generating, with the processor, a source characteristic measurement based upon the source image representation;
generating, with the processor, a destination image representation of a destination image in a second color space, the destination image having a distinct structure from the source image; and
transforming, with the processor, a destination characteristic measurement of the destination image representation based upon the source characteristic measurement of the source image representation.

22. (canceled)

23. (canceled)

24. (canceled)

25. (canceled)

26. (canceled)

27. (canceled)

28. (canceled)

29. (canceled)

30. (canceled)
